(19) United States
(12) Patent Application Publication
(10) Pub. No.: US 2013/0309880 A1
(43) Pub. Date: Nov. 21, 2013

(54) CONNECTOR WITH SENSING COMPONENT

(71) Applicant: Nai-Chien CHANG, New Taipei City (TW)

(72) Inventor: Nai-Chien CHANG, New Taipei City (TW)

(21) Appl. No.: 13/892,609

(22) Filed: May 13, 2013

(30) Foreign Application Priority Data
May 16, 2012 (TW) 101209252

(51) Int. Cl. G01P 15/18; H01R 12/52

(52) U.S. Cl. CPC G01P 15/18; H01R 12/52
USPC 439/78

(57) ABSTRACT

A connector with a sensing component comprises an insulated base, a conductive terminal set, a printed circuit board, an insulated bottom plate, and a metal al case. The printed circuit board electrically connects with a sensing component that has a triaxial accelerator, a gyroscope or a motion sensor into a connector. While an electronic device or electrical equipment electrically connecting with the connector is rotating or is tilting, the connector may output a triaxial variation signal in order to change the displaying orientation of the screen of the electronic device or cut off the power of the electrical equipment.

### BACKGROUND OF THE INVENTION

1. Field of the Invention

The present invention generally relates to a connector, more particularly to a connector that has a sensing component.

2. Description of the Related Art

With the constant progress of multimedia and communications technology, there are many electronic devices that change the displaying orientations, such as horizontal or vertical, of the screens thereof with users' demands while the electronic devices are in use.

Nowadays, for digital camera in market is in operations, the user will turn the camera 90 degrees for vertical shooting, then the user wants to watch photographs that are just taken, the digital camera will automatically and reversely turn the vertical photographs 90 degrees in order to let the user conveniently watch the vertical photographs. As well as the most popular goods, such as smart phones and tablet PCs, users use the smart phones or tablet PCs, the smart phones or tablet PCs may change the display orientations horizontally or vertically according to the directions of the users. It is for the conveniences of users as well.

The digital camera, smart phone and tablet PC have the function of changing displaying orientations of screens to horizontal or vertical with the usage orientations of users. Such devices, digital camera, smart phone and tablet PC, are additionally equipped with triaxial accelerator, gyroscope or motion sensor design in the main printed circuit board of an electronic device, or software programs of changing displaying orientation are installed directly on the microprocessor or memory. Hence, while a user needs to change the display orientation, the user will make a decision in the preset options of a electronic device and thus rotates the electronic device, and the displaying orientation of the screen can be changed. Such function may trouble the design of the main printed circuit board, so as to increase the cost of manufacturing and complicate the usage of the electronic device.

In addition, the main circuit boards of some electrical equipment, such as heaters, are installed centrifugal switches. When the electrical equipment is tilted or lain on the ground, a signal from the centrifugal switch can be output to cut off the power of the main circuit board. Although this approach can achieve the safe usage, but can also cause suffering on the main circuit board and increase production costs.

### SUMMARY OF THE INVENTION

The main objective of the present invention is to solve the shortcomings of related arts. The present invention installs a sensing component of a triaxial accelerator, a gyroscope or a motion sensor into a connector. When an electronic device is rotating or the electric equipment is tilting, the sensing component outputs a triaxial variation signal.

The other objective of the present invention is to use the sensing component to produce the triaxial variation signal in order to change the displaying orientation of the screen of the electronic device.

The other objective of the present invention is to use the sensing component to produce the triaxial variation signal in order to turn off the power of the electric equipment.

To approach above objectives, the present invention provides a connector with a sensing component. The connector electrically connects with an electronic device or a main printed circuit board of electric equipment and comprises:
an insulated base, which has a body thereon, the body has a retaining wall, the retaining wall outwardly extends to form a tongue member, the surface of the tongue member is disposed a plurality of grooves, the grooves are corresponding to a plurality of holes of the retaining wall;
a conductive terminal set, which is formed by a plurality of pins, each of the pins has a front pin and a rear pin, the front pin goes through the hole and fixes in the groove;
a printed circuit board, which has the sensing component thereon, the sensing component firmly and electrically connects with the printed circuit board, one end of the printed circuit board has a plurality of through holes that are through by the rear pins for the rear pins electrically connecting with the printed circuit board, another end of the printed circuit board electrically connects with a plurality of electrode terminals, the electrode terminals electrically connect with the main printed circuit board;
wherein when the electronic device is rotating or the electric equipment is tilting, the sensing component outputs a triaxial variation signal to the main printed circuit board;
wherein the body is hollow, the retaining wall of the body outwardly extends to forma chassis, each of the two sides of the body has a bump and a breach that are symmetrical to each other, one end of the bump is a bolt, the bolt has a fixing portion, each of the two inner side walls f the body has a pair of sunken assembling portions;
wherein the pin has a latching portion, the latching portion connects with the fro pin and the rear pin;
wherein the electrode terminals are formed by a plurality of electrode pins;
wherein the sensing component is selected from the group consisted of: triaxial accelerator, gyroscope and motion sensor;
wherein the connector further comprises an insulated bottom plate, the insulated bottom plate is an L-shape member and has a retaining portion, the retaining portion has a loading portion in order to load the printed circuit board, the loading portion has a plurality of penetrated holes for the electrode pins of the electrode terminal set going through, each of two sides of the loading portion has a pair of connecting portions assembled with the assembling portions;
wherein the connector further comprises a metal case, the metal case has a case member, the case member has an interface and a flap, each of a top surface and a bottom surface has a plurality of flexible pieces, each of two sides of the case member is folded to form a lateral plate, the lateral plate extends to form a set of fixing legs;
wherein the lateral plate has a fillister, an open is formed between the lateral plate and the flap, the open and the fillister assemble with the bump and the bolt, an upper wall surface of the fillister has two fixing portions assembled to two positioning portions of the bolt;
wherein the electronic device further comprises a screen, when the electronic device is rotating, the triaxial variation signal produced by the sensing component is output to the main printed circuit board, the screen changes a displaying orientation after the main printed circuit board processes the triaxial variation signal;
wherein when the electric equipment is tilting, the triaxial variation signal produced by the sensing component is output to the main printed circuit board, the main printed circuit board then turns off the power of the electric equipment.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic top view of the connector of the present invention;

FIG. 2 illustrates a schematic bottom view of the connector of the present invention;

FIG. 3 illustrates a schematic top assembling view of the connector of the present invention;

FIG. 4 illustrates a schematic bottom assembling view of the connector of the present invention; and

FIG. 5 illustrates a schematic operation view of the connector of the present invention.

### DETAILED DESCRIPTION OF THE INVENTION

Following preferred embodiments and figures will be described in detail so as to achieve aforesaid objects.

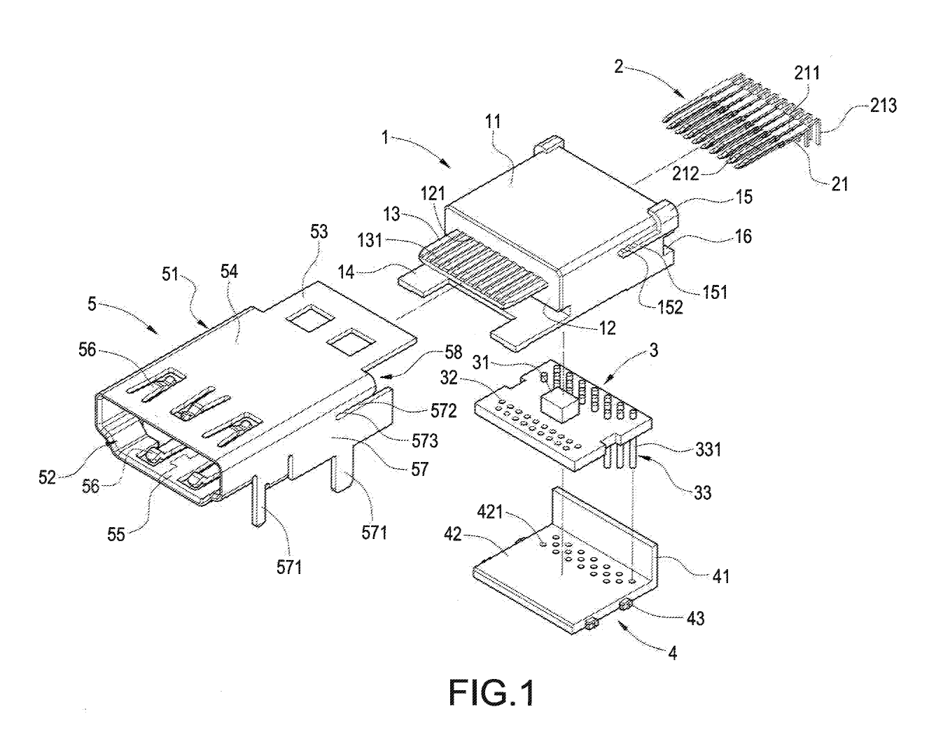

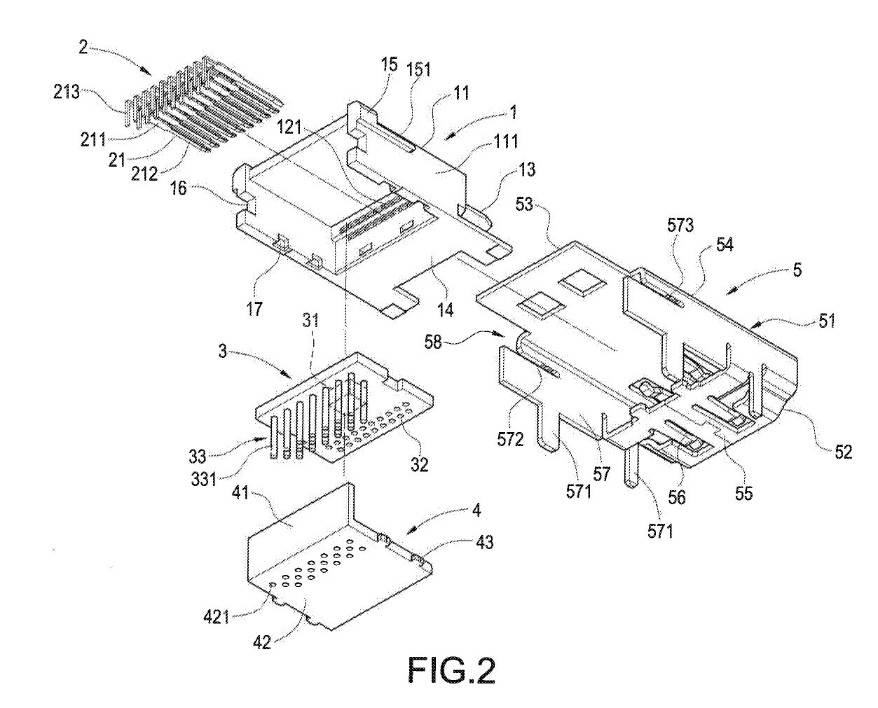

Referring to FIG. 1 and FIG. 2, which illustrate a schematic top view of the connector of the present invention and a schematic bottom view of the connector of the present invention. As shown in figure, the connector with a sensing component includes an insulated base 1, a conductive terminal set 2, a printed circuit board 3, an insulated bottom plate 4, and a metal case 5.

The insulated base 1 has a hollow body 11 thereon, the body 11 has a retaining wall 12, the retaining wall 12 outwardly extends to form a tongue member 13 and a chassis 14, the surface of the tongue member 13 is disposed a plurality of grooves 131, the grooves 131 are corresponding to a plurality of holes 121 of the retaining wall 12, the holes 121 is for front pins 212 of the conductive terminal set 2 going through, an that the front pins 212 are able to insert into the grooves 131. Further, each of the two sides of the body 11 has a bump 15 and a breach 16 that are symmetrical to each other, one end of the bump 15 is a bolt 151, the bolt 151 has a fixing portion 152, the fixing portion 152 is to assemble with a fixing portion 573 of the metal case 5. More, each of two inner side walls of the body 11 has a pair of sunken assembling portions 17, each of two sides of a loading portion 42 of the insulated bottom plate 4 has a pair of connecting portions 43 assembled to the assembling portions 17.

The conductive terminal set 2 is formed by a plurality of pins 21, the pin 21 has a latching portion 211, the latching portion 211 extends to form a front pin 212 and the rear pin 213 vertically bent. The front pin 212 goes through the hole 121 and thus fixes in the groove 131, and the latching portion 211 latches in the hole 121, and the rear pin 213 electrically connects with the printed circuit board 3.

The printed circuit board 3 has the sensing component 31 thereon, the sensing component 31 firmly and electrically connecting with the printed circuit board 3 and senses the orientation of rotation of an electronic device (not shown in figure) in order to change the orientation of displaying of a screen for convenience of user. Further, one end of the printed circuit board 3 has a plurality of through holes 32 that are through by the rear pins 213 of the pins 21 for the rear pins 213 electrically connecting with the printed circuit board 3, another end of the printed circuit board 3 electrically connecting with a plurality of electrode terminals 33, and the electrode terminals 33 are formed by a plurality of electrode pins 331. The insulated bottom plate 4 has a plurality of penetrated holes 421 for the electrode pins 331 going through. As shown in figure, the sensing component 31 is triaxial accelerator, gyroscope or motion sensor.

The insulated bottom plate 4 is an L-shape member and has a retaining portion 41, the retaining portion 41 has a loading portion 42 in order to load the printed circuit board 3, the loading portion 42 has a plurality of penetrated holes 421 for the electrode pins 331 of the electrode terminal set 33 going through and electrically connecting a main printed circuit board (not shown in figure) of the electronic device. More, each of the two sides of the loading portion 42 has a pair of connecting portions 43 assembled to the assembling portions 17.

The metal case 5 has a case member 51, the case member 51 has an interface 52 and a flap 53, the interface 52 is for the insertion of connecting terminals (not shown in figure) of transmission lines. Further, each of a top surface 54 and a bottom surface 55 has a plurality of flexible pieces 56, each flexible piece 56 lets each connecting member (not shown in figure) of the connecting terminal firmly and electrically connect with the conductive terminal set 2 while the flexible piece 56 inserting into the interface 52. each of two sides of the case member 51 is folded to form a lateral plate 57, the lateral plate 57 extends to form a set of fixing legs 571. The fixing leg 571 is able to firmly and electrically connect the case member 51 and the main printed circuit board of the electronic device. The lateral plate 57 has a fillister 572, an open 58 is formed between the lateral plate 57 and the flap 53, the open 58 and the fillister 572 assemble with the bump 15 and the bolt 151, an upper wall surface of the fillister 572 has two fixing portions 573 assembled with two positioning portions 152 of the bolt 151 after the bolts 151 get into the fillisters 572, so as to prevent the looseness of the insulated base 1.

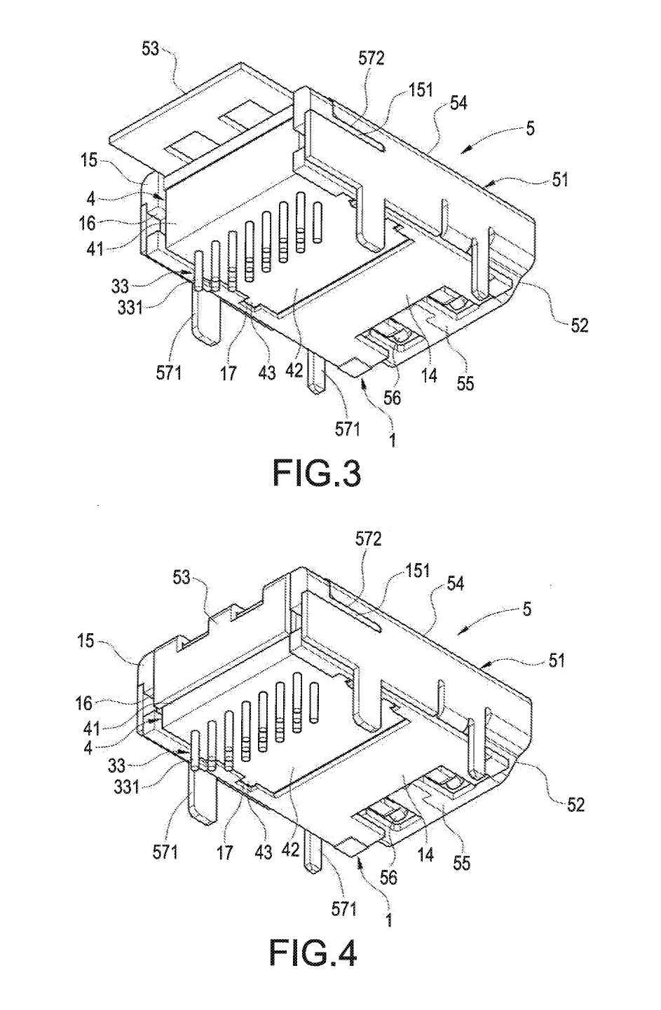

Referring to FIG. 3 and FIG. 4, which illustrate a schematic top assembling view of the connector of the present invention and a schematic bottom assembling view of the connector of the present invention. As shown in figure, while the connector is in assembly, the front pins 212 of the conductive terminal set 2 go through the holes 121, the front pins 212 assemble with the grooves 131 of the tongue member 13, the rear pins 213 of the pins 21 thus penetrate through the through holes 32 in order to electrically connect with the printed circuit board 3. The electrode pins 331 of the electrode terminals 33 of the printed circuit board 3 go through the penetrated holes 421, the connecting portions 43 of the two sides of the loading portion 42 assemble with the assembling portions 17 of the two sides of the inner wall of the body 11, the retaining portion 41 of the insulated bottom plate 4 is disposed at the rear end of the insulated base 1.

After assembling the insulated base 1, the conductive terminal set 2, the printed circuit board 3, and the insulated bottom plate 4, the insulated base 1 is assembled in the metal case 5, the tongue member 13 of the insulated base 1 extends into the interface 52. Further, to fold the flap 53 at the rear end of the metal case 5, the insulated base 1 just can install in the metal case 5.

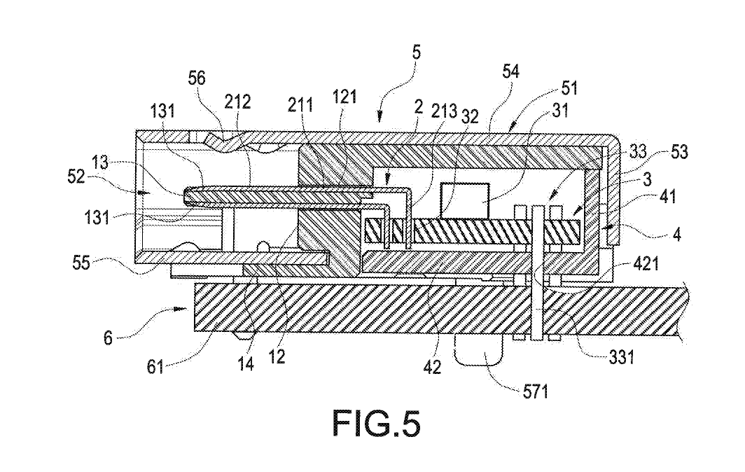

Referring to FIG. 5, which illustrates a schematic operation view of the connector of the present invention. As shown in figure, while the connector is in operations, the electrode pins 331, extending external to the connector, of the electrode terminal set 33 penetrate through the electronic device 6 or the main printed circuit board 61 of the electric equipment, and they are electrically connected to each other, then the connecting members (not shown in figure) of the transmission lines insert into the interface 52, the signals are transmitted from the conductive terminal set 2 to the printed circuit board 3. The electrode pins 331 of the electrode terminals 33 of the printed circuit board 3 may transmit the signals to the main printed circuit board 61.

When the electronic device 6 is rotating or the electric equipment is tilting or dumping, the triaxial variation signals produced by the sensing component 31 are output, and the electrode pins 331 of the electrode terminals 33 of the printed circuit board 3 transmit the signals to the main printed circuit board 61. After calculations of a control unit (not shown in figure) of the main printed circuit board 61, the screen changes displaying orientations or the power of the electric equipment is turned off.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A connector with a sensing component, which electrically connects with an electronic device (6) or a main printed circuit board (61) of electric equipment, comprising:
an insulated base (1), which has a body (11) thereon, the body (11) having a retaining wall (12), the retaining wall (12) outwardly extending to form a tongue member (13), the surface of the tongue member (13) being disposed a plurality of grooves (131), the grooves (131) being corresponding to a plurality of holes (121) of the retaining wall (12);
a conductive terminal set (2), which is formed by a plurality of pins (21), each of the pins (21) having a front pin (212) and a rear pin (213), the front pin (212) going through the hole (121) and fixing in the groove (131); and
a printed circuit board (3), which has the sensing component (31) thereon, the sensing component (31) firmly and electrically connecting with the printed circuit board (3), one end of the printed circuit board (3) having a plurality of through holes (32) that are through by the rear pins (213) for the rear pins (213) electrically connecting with the printed circuit board (3), another end of the printed circuit board (3) electrically connecting with a plurality of electrode terminals (33), the electrode terminals (33) electrically connecting with the main printed circuit board (61);
wherein when the electronic device (6) is rotating or the electric equipment is tilting, the sensing component (31) outputting a triaxial variation signal to the main printed circuit board (61).

2. The connector according to claim 1, wherein the body (11) is hollow, the retaining wall (12) of the body (11) outwardly extending to form a chassis (14), each of the two sides of the body (11) having a bump (15) and a breach (16) that are symmetrical to each other, one end of the bump (15) being a bolt (151), the bolt (151) having a fixing portion (152), each of two inner side walls of the body (11) having a pair of sunken assembling portions (17).

3. The connector according to claim 2, wherein the pin (21) has a latching portion (211), the latching portion (211) connecting with the front pin (212) and ear pin (213).

4. The connector according to claim 3, wherein the electrode terminals (33) is formed by a plurality of electrode pins (331).

5. The connector according to claim 4, wherein the sensing component (31) is selected from the group consisted of: triaxial accelerator, gyroscope and motion sensor.

6. The connector according to claim 5 further comprising an insulated bottom plate (4), the insulated bottom plate (4) being an L-shape member and having a retaining portion (41), the retaining portion (41) having a loading portion (42) in order to load the printed circuit board (3), the loading portion (42) having a plurality of penetrated holes (421) for the electrode pins (331) of the electrode terminal set (33) going through, each of two sides of the loading portion (42) having a pair of connecting portions (43) assembled with the assembling portions (17).

7. The connector according to claim 6 further comprising a metal case (5), the metal case (5) having a case member (51), the case member (51) having an interface (52) and a flap (53), each of a top surface (54) and a bottom surface (55) having a plurality of flexible pieces (56), each of two sides of the case member (51) being folded to form a lateral plate (57), the lateral plate (57) extending to form a set of fixing legs (571).

8. The connector according to claim 7, wherein the lateral plate (57) has a fillister (572), an open (58) being formed between the lateral plate (57) and the flap (53), the open (58) and the fillister (572) assembling with the bump (15) and the bolt (151), an upper wall surface of the fillister (572) having two fixing portions (573) assembled to two positioning portions (152) of the bolt (151).

9. The connector according to claim 8, wherein the electronic device (6) further comprises a screen, when the electronic device (6) is rotating, the triaxial variation signal produced by the sensing component (31) being output to the main printed circuit board (61), the screen changing a displaying orientation after the main printed circuit board (61) processes the triaxial variation signal.

10. The connector according to claim 8, wherein when the electric equipment is tilting, the triaxial variation signal produced by the sensing component (31) being output to the main printed circuit board (61), the main printed circuit board (61) then turning off the power of the electric equipment.
